(19) United States
(12) Patent Application Publication
(10) Pub. No.: US 2017/0154533 A1
(43) Pub. Date: Jun. 1, 2017

(54) DETECTION SYSTEM FOR A MOTOR VEHICLE, FOR INDICATING WITH THE AID OF A SOUND STAGE A LACK OF VIGILANCE ON THE PART OF THE DRIVER IN THE PRESENCE OF IMMEDIATE DANGER

(71) Applicant: RENAULT s.a.s., Boulogne-Billancourt (FR)

(72) Inventor: Herve ILLY, Meudon (FR)

(73) Assignee: RENAULT s.a.s., Boulogne-Billancourt (FR)

(21) Appl. No.: 15/317,878

(22) PCT Filed: Jun. 8, 2015
(86) PCT No.: PCT/FR2015/051514

§ 371 Date: Dec. 9, 2016

(30) Foreign Application Priority Data
Jun. 10, 2014 (FR) 1455239

(51) Int. Cl. G08G 1/16; B60W 50/14; B60W 40/09

(52) U.S. Cl. CPC G08G 1/166; G08G 1/165; B60W 40/09; B60W 50/14; G08G 1/167; B60W 2540/22; B60W 2050/143; B60W 2550/10

(57) ABSTRACT

A system detects a lack of vigilance by a driver of a motor vehicle. The system includes a first monitoring unit to assess whether a vigilance of the driver is or is not above a vigilance threshold, at least one second monitoring unit to identify at least one type of danger linked to a trajectory and/or to an environment of the vehicle, at least two distinct loudspeakers, and a sound stage generator to control the at least two loudspeakers so as to simulate a sound originating from a virtual sound source that is mobile relative to a seat of the driver. The sound stage generator simulates a sound stage with mobile virtual source when the vigilance level detected is below the threshold and a danger of given type is identified.

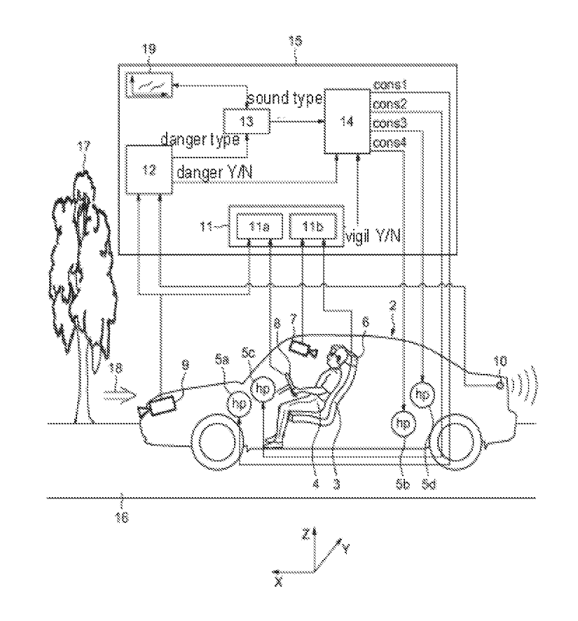

The subject of the invention is the safety systems for motor vehicles and more particularly the systems intended to limit the risks associated with driving in a state of diminished vigilance of the driver of the vehicle.

Systems for detecting a lowering of vigilance of the driver do exist. These systems can for example be linked to a monitoring of micro-movements of the driver on the steering wheel to an analysis of images of the visual expressions of the face of the driver, to sensors in the seat monitoring the bearing points of the body and more particularly the head of the driver.

When a lowering of vigilance is detected, alerts are provided for the attention of the driver such as, for example, a visual display on the dashboard, a tactile alert in the form of a vibration in the steering wheel or the seat, or an acoustic signal such as, for example, a ringer. Thus, for example, in the patent application EP 131 2499 when a detection system detects that the vehicle is in the process of leaving its lane, the system emits three alert levels, an optical alert level, an acoustic alert level and a vibratory alert level in the seat or the steering wheel.

Other alert systems that already exist warn, for example, that the driver is in a distracted state by a sound signal accompanied by a display of a message of “break advised” type, for example by displaying a small coffee cup. The patent application EP 20 42 398 proposes emitting a sound signal or a light signal at the moment when a monitoring system detects that the vehicle leaves its lane or detects that the driver performs an inappropriate action in a lane changing context.

Alert modalities proposed in these embodiments risk either being unseen by the driver if the latter in a state of diminished awareness is already not watching his or her dashboard, or risk increasing the confusion of the driver if the latter can no longer remember with which type of alarm the ringer that he or she is hearing is linked. The alert can provoke abrupt gestures also risking affecting the trajectory, for example in the case of vibration reawaking the driver with a jump from his or her micro-sleep.

The aim of the invention is to propose a detection system which interacts with the driver in such a way as to make the driver aware, effectively, of his or her lack of vigilance. The system can further provide the driver with information to assist him or her in reacting appropriately to any dangers threatening the vehicle or its passengers.

To this end, the invention proposes a system for detecting a lack of vigilance on the part of a driver of a motor vehicle, comprising a first monitoring unit capable of assessing whether the vigilance of the driver is or is not above a vigilance threshold, and comprising at least one second monitoring unit configured to identify at least one type of danger linked to the trajectory and/or to the environment of the vehicle. The detection system further comprises at least two distinct loudspeakers. The system further comprises a sound stage generator capable of controlling the at least two loudspeakers so as to simulate a sound originating from a virtual sound source that is mobile relative to the seat of the driver, the sound stage generator being configured to simulate a sound stage with mobile virtual source when the vigilance level detected is below the threshold and a danger of given type is identified.

The system can further comprise a sound selection unit configured to associate at least two different sound stages with two different types of dangers, the sound stage generator being configured to simulate the virtual sound source selected by the selection unit.

When the danger is an obstacle toward which the vehicle is moving, the sound pattern selected can simulate a virtual sound source approaching the vehicle substantially from the obstacle.

Preferably, the sound stage generator is connected to at least three distinct loudspeakers, including at least one loudspeaker on the right and one loudspeaker on the left of the driver's seat, at least two of the at least three loudspeakers being further spaced apart in the direction of advance of the vehicle.

The second monitoring unit can be configured to detect a trajectory deviation above a threshold and to detect a trajectory deviation sign, and the sound selection unit can be configured to associate, with this trajectory deviation above a threshold, a sound stage whose virtual sound source is located either on the right, or on the left of the vehicle as a function of the trajectory deviation sign.

The sound stage associated with the trajectory deviation preferably comprises a sound which simulates a virtual sound source approaching the vehicle.

The sound stage associated with the trajectory deviation can also comprise, preferably following the sound simulating a virtual sound source approaching the vehicle, a noise likely to evoke a noise of impact of the vehicle against an obstacle.

The second monitoring unit can be configured to detect another vehicle coming in the direction opposite to the equipped vehicle, and the sound selection unit can be configured to associate, with this approach of another vehicle, a sound stage simulating a virtual sound source approaching the equipped vehicle from the front.

The second monitoring unit can be configured to identify a different danger depending on whether the vehicle in the opposite direction is or is not located in the same lane as the vehicle equipped with the system, or to not identify a danger if the vehicle is located in a different lane.

Advantageously the selection unit is configured to associate, with this approach of another vehicle, in the same lane as the equipped vehicle, a sound stage comprising a noise likely to evoke an impact between two vehicles.

The loudspeakers are preferably installed in the vehicle in such a way that at least two loudspeakers are located at a distance from one another of at least fifty centimeters, so as to be able to obtain a stereophonic effect. Preferably the system comprises at least four loudspeakers, two situated with one on the right and the other on the left relative to the driver's seat, in front of the driver's seat or level therewith, and two loudspeakers situated with one on the right and the other on the left relative to the driver's seat, and offset toward the rear of the vehicle relative to the first two loudspeakers.

The system is thus configured to attract the attention of the driver, when the vigilance thereof is relaxed, to the trajectory correction direction which could be imposed on the driver while he or she refocuses his or her attention on the environment of the vehicle. The system thus, if necessary, makes it possible for the driver to react more rapidly in a relevant manner to the immediate danger. The obstacle toward which the vehicle is moving may be an immobile obstacle relative to the roadway, for example a tree, or can be a moving obstacle relative to the roadway, for example a vehicle coming in the opposite direction to the equipped vehicle, or even a vehicle approaching the equipped vehicle from the rear at high speed. The expression “substantially from the obstacle” should be understood to mean that the virtual sound source seems to be approaching the driver substantially in the same direction as the relative direction of approach of the obstacle with respect to the driver. The rate of approach of the virtual sound source may be different to, for example faster than, the relative rate of approach of the obstacle. The driver can thus more rapidly become aware of the relative direction of approach of the danger and of the trajectory correction direction which could be adapted. Even if the virtual source is mobile, its movement is preferably a continuous movement or a repetition of continuous movements, so as to be able to be located intuitively by the driver and not to induce unease associated with difficulty in interpreting the sound stage.

Other aims, features and advantages of the invention will become apparent on reading the following description, given purely as a non-limiting example, and with reference to the attached figure, which illustrates a motor vehicle equipped with a detection system according to the invention.

As illustrated in the figure, a detection system 1 equips a vehicle 2 comprising a seat 3 intended to receive a driver 4. In the example illustrated, when a driver 4 is sitting on the seat 3, he or she is within the field of a camera 7 for monitoring the attitude of the driver, actuates a steering wheel 8 of the vehicle, acts on motion sensors 6 located in the seat 3 of the vehicle. The sensors 6, and the camera 7, or more generally at least one sensor suitable for monitoring the posture, behavior or physiology of the driver, are linked to a module 11b monitoring the behavior of the driver, which emits a first “vigil” estimation concerning the level of vigilance of the driver.

The vehicle 2 is also equipped with a camera 9 making it possible to monitor the roadway 16 on which the vehicle is running and any obstacles 17 located in particular on the roadway. The vehicle can also be equipped with one or more radars 10 making it possible to detect obstacles in proximity to the vehicle, for example a vehicle which is approaching too close to the rear of the equipped vehicle, or an obstacle located in front of the vehicle 2. The steering wheel 8 is, here equipped with at least one sensor making it possible to measure the steering wheel angle variations imposed by the driver. The sensor of the steering wheel 8, and the camera 9, or more generally at least one sensor monitoring at least one driving modality of the driver, are linked to a module 11a monitoring driving actions of the driver. This monitoring module monitors the way in which the driver interacts with the vehicle, for example this monitoring module monitors the micro-movements of the steering wheel, and/or monitors the regularity of the trajectory and/or how well it matches the line of the road. Modalities for monitoring the physiology, and modalities for monitoring the behavior of the driver in order to assess the level of vigilance of the driver are known.

The module 11a and the module 11b form part of a first monitoring unit 11, which, based on the analyses of the modules 11a and 11b emits a “vigil” variable reflecting an estimated level of vigilance with the driver. The modules 11a and 11b can process the variables from the physiological sensors and the variables from the driving action sensors independently or can supply intermediate variables re-analyzed jointly by the monitoring unit 11. This variable crosses a threshold when the level of vigilance of the driver becomes unsatisfactory. The “vigil” variable can be boolean type, or can be a continuous variable to which can be assigned a threshold reflecting a limit level of vigilance of the driver. The first monitoring unit 11 forms part of an electronic control unit 15 further comprising a second monitoring unit 12, a sound selection unit 13 and a sound stage generator 14.

The camera 9 and the radar 10 can further be linked to the second monitoring unit 12 making it possible to monitor the trajectory and the environment of the vehicle, for example making it possible to monitor the conformity of the trajectory relative to the line of the road. The unit can check that the trajectory of the vehicle lies within an envelope of “safe” trajectories which can be wider than the envelope of trajectories indicating the vigilance on the part of the driver. The environment of the vehicle can comprise obstacles or vehicles detected in front of or behind the vehicle, for example by the camera 9 or by the radar 10.

The vehicle 2 can be fixed in the space by a longitudinal axis X corresponding to the direction of movement of the vehicle, by a transverse axis Y which is also a horizontal axis and by a vertical axis Z.

The vehicle here comprises four loudspeakers 5a, 5b, 5c and 5d, which are preferably distributed in such a way that at least three loudspeakers are spaced apart in pairs in a plane XY, so as to be able to simulate the virtual sources moving around in various directions in this plane XY relative to the vehicle. These loudspeakers can have multiple functions, for example can have a standard function of broadcasting an ambient sound installation of the vehicle, by being linked to a radio, to an audio storage drive, and/or a hands-free device for a smartphone. If there are more than two of the loudspeakers, they can be distributed also at different heights relative to the driver and can make it possible to simulate a virtual source that is mobile also relative to a vertical axis Z.

The second monitoring unit 12 emits a “danger” variable—for example boolean—for the attention of a sound stage generator 14 which also receives the “vigil” variable reflecting the state of the vigilance of the driver 4. The boolean “danger” variable indicates if any danger has been detected. The monitoring unit 12 further emits one or more “danger type” variables to the sound selection unit 13 which consults a sounds database 19 and sends to the sound stage generator 14 “sound type” data making it possible to generate a particular sound stage as a function of the type of danger.

The monitoring unit 12 can for example emit a group of boolean “danger type” variables, i.e. a variable for each type of danger (trajectory deviation to the left, trajectory deviation to the right, vehicle approaching from the rear, obstacle in front approaching the vehicle, etc.), or can for example emit a single integer variable, each value of the variable being associated with a particular type of danger.

Generally, and for the rest of the explanations, the “vigil” variable decreases when the vigilance of the driver diminishes, but equivalent embodiments are of course possible with a “vigil” variable which increases when the vigilance of the driver is degraded. The “vigil” variable can also be a boolean.

If the level of vigilance of the driver 4 therefore passes below a certain threshold, the sound stage generator 14 uses the “sound type” variable or variables that are transmitted to it by the sound selection unit 13. A certain alert sound pattern is therefore assigned as a function of the danger detected, and this pattern is used, or not, as a function of the level of vigilance of the driver. Preferably, this pattern is assigned only when the driver exhibits a state of vigilance below the programmed vigilance threshold. The sound stage generator 14 sends sound signal setpoints as a function of time cons1, cons2, cons3, cons4, respectively to the four loudspeakers 5a, 5c, 5d, 5b so as to produce a sound stage pattern associated with the danger detected. The patterns defined by the four setpoints cons1, cons2, cons3, cons4 differ by their phase and/or by their intensity so as to generate a stereophonic sound and create the illusion for the driver of a virtual sound source in motion relative to the driver. In this way, the driver perceives the sound stage as a message that is clearly distinct from the other noise sources present around him, distinct from the other spot sound messages, even distinct from stereophonic background music. It has in fact been demonstrated that the simple fact of emitting messages of different types as originating from virtual sources each positioned differently relative to a pilot or to a driver, enables the pilot or the driver to better extract each message from the surrounding sound background context. All the more so if the virtual sound source is mobile, the corresponding signal can only stand out more from the sound background.

Stereophonic sound should be understood to mean a sound which, for a person situated at a given point, here for a person seated on the seat 3 of the driver, seems to originate from a virtual sound source located at a point of space which does not necessarily correspond to the position of one of the loudspeakers, this virtual sound source being able to move around in this space by virtue of the driving by the sound stage generator 14, the phase shifts between the different sound patterns and between the volumes of the different sound patterns emitted by each of the loudspeakers 5a, 5b, 5c, 5d. A sound stage should be understood here to also mean a movement of the virtual sound source.

Virtual sound source should be understood to mean the point of space from which the sound ought to be emitted, to produce the same sound rendition to the driver; if the sound were emitted by a real spot source instead of being emitted by the different loudspeakers of the vehicle.

The direction and the rate of movement of the virtual sound source, the amplitude or the frequency of the sound, can be modulated as a function of the type of danger detected, and can also be modulated as a function of the detection or non-detection of a reaction on the part of the driver to the first sound message which is addressed to him or her during one and the same episode of lack of vigilance.

For example, if the vehicle 2 approaches an obstacle 17 on the roadway or at the edge of the roadway and risks striking this obstacle 17, the sound stage selected by the unit 13 and then generated by the sound stage generator 14 can correspond to a sound originating from a virtual sound source approaching the vehicle 2 in the direction 18 of relative movement of the obstacle relative to the vehicle, the virtual sound source having a speed of approach relative to the vehicle 2 that is either equal to the speed of approach of the obstacle or greater than the latter.

The movement effect of the virtual sound source can further be accompanied, either continuously, or in spot fashion after a certain level of approach of the virtual sound source, by a noise evoking a noise of steel plate undergoing plastic deformation, or by an impact noise, to evoke the impact of the vehicle which risks occurring if the driver does not react appropriately.

Depending on the number of loudspeakers available, the virtual sound source can be placed in such a way that the driver clearly perceives that the obstacle announced risks being located more on the right part or on the left part of the roadway. Similarly, when the monitoring unit 2 detects that the vehicle risks leaving the roadway or crossing the center line of the roadway, the sound selection unit 13 can select a stereophonic sound which can for example originate from the side of the roadway that the driver of the vehicle should be careful not to get closer to. The sound stage can be emitted by a virtual sound source moving from the front to the rear of the vehicle—if the vehicle is moving forward for example—directly from the front or with a lateral bias based on the type of danger.

The invention is not limited to the exemplary embodiments described and can be broken down into many variants. The monitoring units 11, 12, the sound selection unit 13 and the sound stage generator 14 can be independent entities or can be grouped together within one and the same electronic control unit 15. The modalities for detection of a lack of vigilance on the part of the driver can be different from those described. The modes for detecting dangers linked to the trajectory of the vehicle and to the surrounding obstacles can also vary.

The virtual sound sources can preferably be stereophonic sounds evoking movement of the virtual sound source, in order to provide additional information concerning the direction and/or the speed of approach of the danger. The detection of the vigilance of the driver can be based solely on one or more physiological measurements, solely on one or more measurements of the driving mode, solely on the quality of the trajectory, or the detection can be performed by a hybrid mode combining two or more of these detection modalities. The methods for detecting the level of vigilance of the driver can involve fewer sensors than the sensors described, or, on the contrary, use additional sensors of a physiological state of the driver (heart rate) or additional sensors of actions of the driver (frequency and mode of intervention on the control elements of the dashboard for example).

The sound stage generator 14 can possibly receive the same “danger type” variable as the sound selection unit 12. According to another variant embodiment, the monitoring unit 12 can emit different variables indicative of the danger to the sound selection unit 13 and to the sound stage generator 14, and, based on the parameterizing of the system, some sound stages can be selected without being synthesized on each selection by the generator 14. They can for example be selected for a first group of danger types, and be synthesized only for a subgroup of these danger types. The vigilance threshold leading to the emission of a sound stage can be variable according to the type of danger identified.

Several levels of intensity of stereophonic messages or of other types of variations of a type of sound associated with a given danger can be provided, notably for the cases where the driver does not react in such a way as to give a perception of an upsurge of vigilance above a threshold, following the first warning stereophonic message during a given lack-of-vigilance episode.

Various sound codes can be chosen to evoke dangers detected, either on the basis of noises evocative of noises linked to the damage the vehicle is likely to suffer, or in the form of more symbolic noise that cannot in itself be correlated to a particular event, other than the driver's experience thereof.

The detection system according to the invention makes it possible to warn the driver of a lack of vigilance by minimizing the possibilities of the driver to ignore the message. It also makes it possible to assist the driver in adapting his or her reactions even before the driver has the time following his or her resumption of vigilance, to re-analyze the situation of the vehicle relative to its environment.

1-10. (canceled)

11. A system for detecting a lack of vigilance by a driver of a motor vehicle, comprising:
a first monitoring unit configured to assess whether a vigilance of the driver is or is not above a vigilance threshold;
at least one second monitoring unit configured to identify at least one type of danger linked to a trajectory and/or to an environment of the vehicle;
at least two distinct loudspeakers;
a sound stage generator configured to control the at least two loudspeakers so as to simulate a sound originating from a virtual sound source that is mobile relative to a seat of the driver, the sound stage generator being configured to simulate a sound stage with mobile virtual source when the vigilance level detected is below the threshold and a danger of given type is identified.

12. The detection system as claimed in claim 11, further comprising a sound selection unit configured to associate at least two different sound stages with two different types of dangers, the sound stage generator being configured to simulate the virtual sound source selected by the selection unit.

13. The detection system as claimed in claim 12, in which, when the danger is an obstacle toward which the vehicle is moving, a sound pattern selected simulates a virtual sound source approaching the vehicle substantially from the obstacle.

14. The detection system as claimed in claim 13, in which the sound stage generator is connected to at least three distinct loudspeakers, including at least one loudspeaker on a right and one loudspeaker on the a of the seat of the driver, at least two of the at least three loudspeakers being further spaced apart in a direction of advance of the vehicle.

15. The detection system as claimed in claim 12, in which the second monitoring unit is configured to detect a trajectory deviation above a threshold, and to detect a trajectory deviation sign, and the sound selection unit is configured to associate, with the trajectory deviation above a threshold, a sound stage whose virtual sound source is located either on a right, or on a left of the vehicle as a function of the trajectory deviation sign.

16. The detection system as claimed in claim 15, in which the sound stage associated with the trajectory deviation comprises a sound which simulates a virtual sound source approaching the vehicle.

17. The detection system as claimed in claim 16, in which the sound stage comprises, following the sound simulating a virtual sound source approaching the vehicle, a noise likely to evoke a noise of impact of the vehicle against an obstacle.

18. The detection system as claimed in claim 12, in which the second monitoring unit is configured to detect a second vehicle coming in a direction opposite to the vehicle, and the sound selection unit is configured to associate, with an approach of the second vehicle, a sound stage simulating a virtual sound source approaching the vehicle from a front of the vehicle.

19. The detection system as claimed in claim 18, in which the second monitoring unit is configured to identify a different danger depending on whether the second vehicle coming in the opposite direction is or is not located in a same lane as the vehicle, and to not identify a danger if the second vehicle is located in a different lane.

20. The detection system as claimed in claim 19, in which the selection unit is configured to associate with the approach of the second vehicle in the same lane as the vehicle, a sound stage comprising a noise likely to evoke an impact between two vehicles.
